(19) United States
(12) Patent Application Publication
(10) Pub. No.: US 2010/0141154 A1
(43) Pub. Date: Jun. 10, 2010

(54) BACKLIGHT MODULE AND METHOD OF CONTROLLING THE LUMINANCE OF THE BACKLIGHT MODULE

(76) Inventors: Ching-Hung Wang, Hsin-Chu (TW); Chien-Ming Ko, Hsin-Chu (TW); Fu-Cheng Wei, Hsin-Chu (TW); Chih-Fu Hsu, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 12/394,053

(22) Filed: Feb. 27, 2009

(30) Foreign Application Priority Data
Dec. 9, 2008 (TW) 097147787

(51) Int. Cl. H05B 37/02

(52) U.S. Cl. 315/151; 315/153; 315/158

(57) ABSTRACT

A backlight module includes a plurality of light sources, a photo-sensor, and a control circuit. Each light source of the plurality of light sources can operate independently. The photo-sensor detects the luminance of the plurality of light sources to generate a luminance signal. The control circuit drives the plurality of light sources according to the luminance signal. When the backlight module is used in a scanning backlight LCD, the control circuit turns off parts of the plurality of light sources according to a display signal. When all of the plurality of light sources is turned on, the control circuit obtains the luminance signal so as to adjust the luminance of the backlight module according to the luminance signal.

### BACKGROUND OF THE INVENTION

1. Field of the Invention

The present invention relates to a backlight module, and more particularly, to a backlight having the luminance control.

2. Description of the Prior Art

Since light emitting diode (LED) has small size and low power consumption, it is generally applied in the light source for the backlight of the liquid crystal display (LCD). In addition, when the backlight of the LCD uses the LED, the LED module is arranged in an array including a plurality of rows and columns. Each row or each column can operate independently, so the LED backlight module can be applied in the scanning backlight LCD. However, because of the material characteristic of the LED, the light-emitting efficiency decreases as the temperature increases. When the LCD is used for a long time, the heat from the light generated by the LED increases the temperature of the environment, resulting in the luminance of the backlight module decreasing. Thus, the LCD uses a photo-sensor to detect the luminance of the backlight module to keep the constant luminance of the backlight module.

Please refer to FIG. 1. FIG. 1 is a schematic diagram of a conventional backlight module. The backlight module 10 includes a plurality of light sources and a photo-sensor 14. The plurality of light sources 12 is an LED module arranged in an array including a plurality of rows and columns. Each row or column can operate independently. The photo-sensor 14 is located closes to the plurality of light sources 12, for detecting the luminance variation of the plurality of light sources 12. As shown in FIG. 1, the photo-sensor 14 is located in the center of the backlight module 10. The photo-sensor 14 generates a luminance signal according to the luminance of the plurality of light sources 12 to keep the constant luminance of the plurality of light sources 12. When the backlight module 10 is used in the scanning backlight LCD, each row or each column of the light sources 12 of the backlight module 10 can operate independently, so the backlight module 10 can turn on or turn off parts of the light sources 12 according to the display signal. However, the luminance of the backlight module 10 decreases when the backlight module 10 turns off parts of light sources 12. If the luminance of the backlight module 10 is adjusted according to the luminance signal detected by the photo-sensor 14 at this time, the luminance of the backlight module 10 will have a great difference.

Pleases refer to FIG. 2. FIG. 2 is a waveform diagram of the control signals of the backlight module 10 in FIG. 1. YDIO represents the scanning signal of the LCD. YCLK represents the clock signal of the LCD. ON represents the backlight is turned on. OFF represents the backlight is turned on. When all light sources 12 of each row of the backlight module 10 are turned on in one frame time, the luminance signal detected by the photo-sensor 14 will keep at a voltage level. When the luminance signal varies, the backlight module 10 adjusts the driving current of the plurality of the light sources according to the luminance signal so as to keep the constant luminance of the backlight module 10.

Please refer to FIG. 3. FIG. 3 is a waveform diagram of the control signals of the backlight module 10 in FIG. 1 for the scanning backlight LCD. The backlight module 10 turns off parts of the light sources according to the display signal of the LCD when the backlight module 10 is used in the scanning backlight LCD. The LCD turns off the corresponding light source 12 where the scan line is turned on according to the display signal to reduce the motion blur of the LCD. Thus, in one frame time, each row of the light sources is turned off for the duration respectively. As shown in FIG. 3, when the 1st˜135th scan lines are turned on, the 1st row of the light sources is turned off; when the 136th˜270th scan lines are turned on, the 2nd row of the light sources is turned off; . . . ; when the 946th˜1080th scan lines are turned on, the 8th row of the light sources is turned off. However, when the parts of the light sources are turned off, the luminance signal detected by the photo-sensor 14 has a low voltage level. When the location of the light sources turned off is closer to the photo-sensor 14, the photo-sensor 14 generates the lower voltage level of the luminance signal. Since the photo-sensor 14 is located corresponding to the 5th row of the light sources, when the 5th row of the light sources is turned off, the voltage level of the luminance signal detected by the photo-sensor 14 is the lowest.

In conclusion, the LCD uses the photo-sensor to detect the luminance of the backlight module so as to keep the constant luminance of the backlight module. However, when the backlight module is used in the scanning backlight LCD, the backlight module turns off parts of the light sources according to the display signal of the LCD. If the luminance of the backlight module is adjusted according to the luminance signal detected by the photo-sensor at this time, the luminance of the backlight module will have a great difference.

### SUMMARY OF THE INVENTION

According to an embodiment of the present invention, a method of controlling the luminance of a backlight module is provided. The method comprises: providing a backlight module having a plurality of light sources; providing a display signal; turning off parts of the plurality of light sources according to the display signal; obtaining the luminance of the backlight module so as to generate a luminance signal when all of the plurality of light sources being turned on; and adjusting the luminance of the backlight module according to the luminance signal.

According to another embodiment of the present invention, a backlight module having the luminance control comprises a plurality of light sources, a photo-sensor, and a control circuit. Each light source is operated independently. The photo-sensor is used for detecting the luminance of the plurality of light sources so as to generate a luminance signal. The control circuit is used for turning off parts of the plurality of light sources according to a display signal and obtaining the luminance signal when all of the plurality of light sources being turned on.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional backlight module.

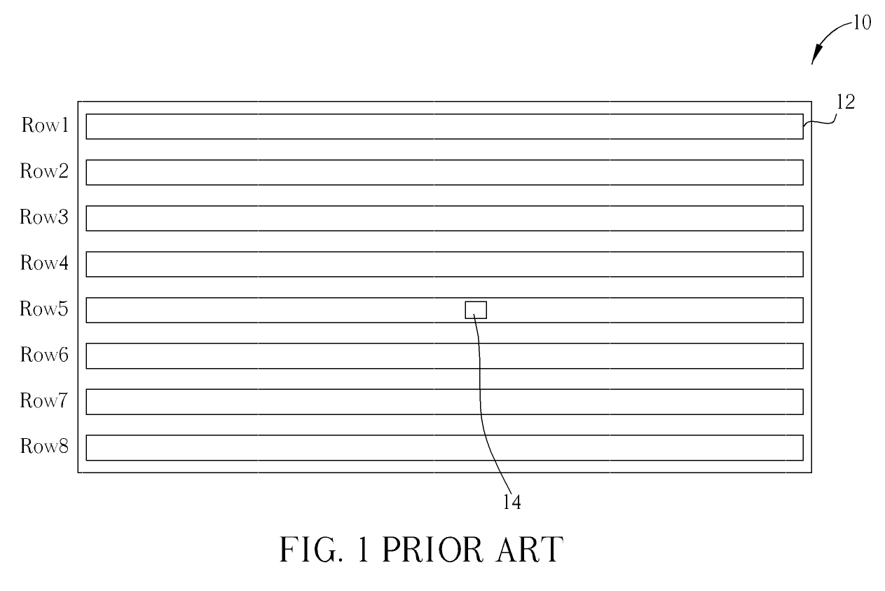

FIG. 2 is a waveform diagram of the control signals of the backlight module in FIG. 1.

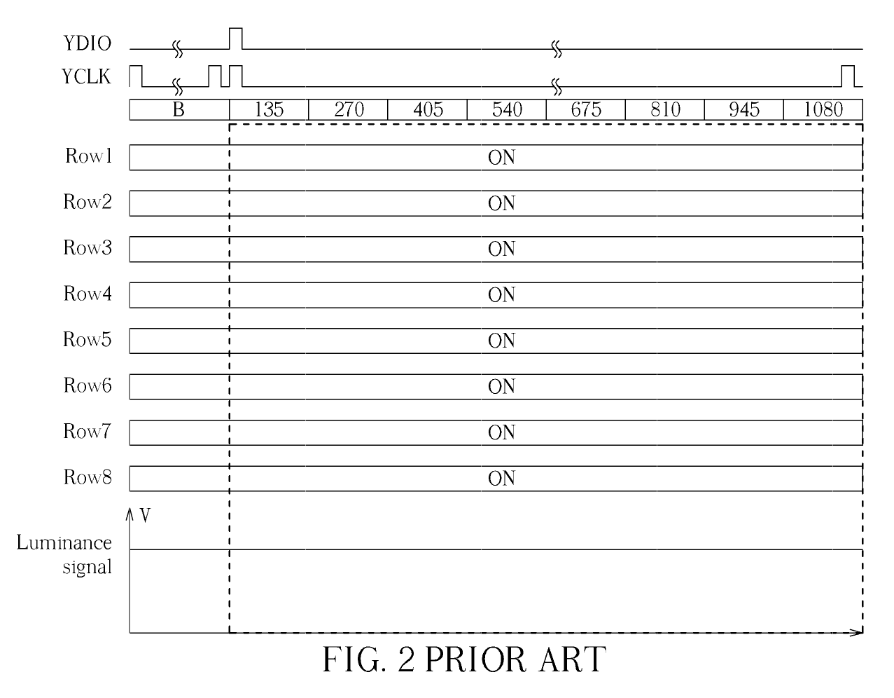

FIG. 3 is a waveform diagram of the control signals of the backlight module in FIG. 1 for the scanning backlight LCD.

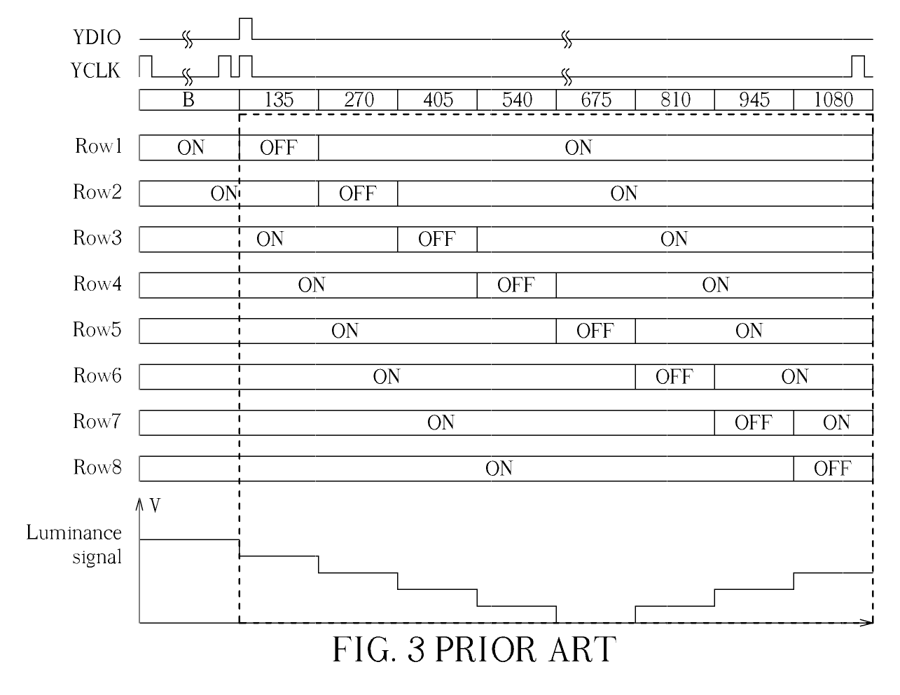

FIG. 4 is a schematic diagram of a backlight module according to the present invention.

FIG. 5 is a schematic diagram of the first embodiment of the backlight module having the luminance control according to the present invention.

FIG. 6 is a schematic diagram of the second embodiment of the backlight module having the luminance control according to the present invention.

### DETAILED DESCRIPTION

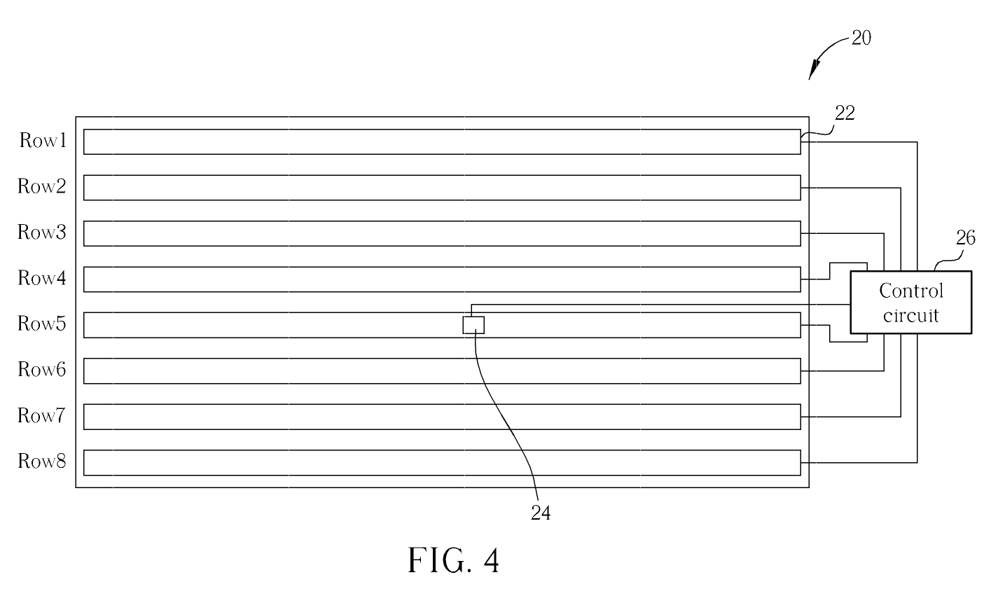

Please refer to FIG. 4. FIG. 4 is a schematic diagram of a backlight module according to the present invention. The backlight module 20 comprises a plurality of light sources 22, a photo-sensor 24, and a control circuit 26. The plurality of light sources 22 is an LED module arranged in an array including a plurality of rows and columns. The plurality of light sources 22 is electrically connected to the control circuit 26. Each row or column can operate independently. The control circuit 26 turns off parts of the plurality of light sources 22 according to a display signal. The photo-sensor 24 is located close to the plurality of light sources 22, for detecting the luminance variation of the plurality of light sources 22. The location of the photo-sensor 24 is not restricted. In general, the photo-sensor 24 is located where the average luminance of the backlight module 20 can be detected. As shown in FIG. 4, the photo-sensor 24 is located in the center of the backlight module 20. The photo-sensor 24 is electrically connected to the control circuit 26. The photo-sensor 24 generates a luminance signal according to the luminance of the plurality of light sources 22 and transmits the luminance signal to the control circuit 26. In the embodiment of the present invention, the backlight module 20 is used in the scanning backlight LCD. When parts of the light sources 22 are turned off according to the display signal, the control circuit 26 does not obtain the luminance signal detected by the photo-sensor 24. When all of the plurality of light sources 22 is turned on, the control circuit 26 obtains the luminance signal detected by the photo-sensor 24.

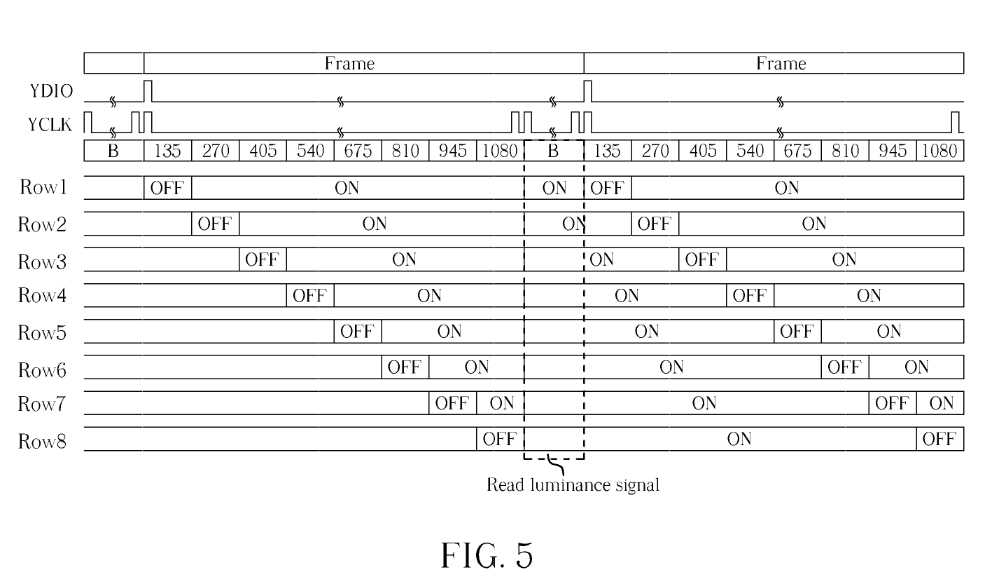

Please refer to FIG. 5. FIG. 5 is a schematic diagram of the first embodiment of the backlight module having the luminance control according to the present invention. The embodiment is illustrated by the backlight module 20 in FIG. 4. The control circuit 26 turns off each row of the light sources 22 according to the display signal. The backlight module 20 uses the photo-sensor 24 to detect the luminance variation of the plurality of light sources 22. The control circuit 26 is formed as a feedback loop to keep the constant luminance of the plurality of light sources 22. However, when the backlight module 20 is used in the scanning backlight LCD, the backlight module 20 turns off parts of the light sources according to the display signal of the LCD. If the control circuit 26 adjusts the luminance of the light sources 22 according to the luminance signal detected by the photo-sensor 24 at this time, the luminance of the backlight module will have a great difference. When the backlight module 20 is used in the scanning backlight LCD, the control signals of the plurality of light sources 22 are shown in FIG. 5. YDIO represents the scanning signal of the LCD. YCLK represents the clock signal of the LCD. ON represents the backlight is turned on. OFF represents the backlight is turned on. The LCD turns off the corresponding light source 22 where the scan line is turned on according to the display signal so as to reduce the motion blur of the LCD. Thus, in one frame time, each row of the light sources is turned off for the duration respectively. When the 1st˜135th scan lines are turned on, the 1st row of the light sources is turned off; when the 136th˜270th scan lines are turned on, the 2nd row of the light sources is turned off; . . . ; when the 946th˜1080th scan lines are turned on, the 8th row of the light sources is turned off. The LCD has a blanking duration B between each frame. In the blanking duration B, all light sources 22 of the backlight module 20 are turned on. Therefore, the control circuit 26 according to the present invention obtains the luminance signal detected by the photo-sensor 24 in the blanking duration B of the LCD. The control circuit 26 can adjust the luminance of the light sources 22 correctly according to the luminance signal obtained in the blanking duration B so as to keep the constant luminance of the light sources 22.

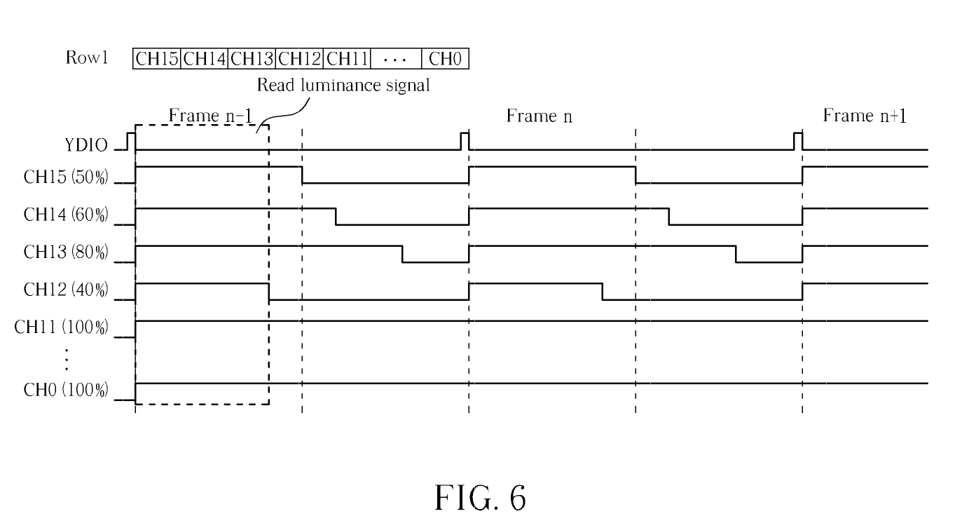

Please refer to FIG. 6. FIG. 6 is a schematic diagram of the second embodiment of the backlight module having the luminance control according to the present invention. Similarly, this embodiment is illustrated by the backlight module 20 in FIG. 4, but the control circuit 26 in this embodiment can operate each row and each column of the light sources independently according to the display signal. For example, each row of the light sources comprises 16 columns of the output channels CH15˜CH0. When the backlight module 20 is used in the scanning backlight LCD, the control circuit 26 can use the duty cycle to control each row and each column of the light sources 22. Taking the 1st row of the light source 22 for example, the duty cycle of the output channel CH15 is 50%, representing the 1st row and the 1st column of the light sources 22 is turned on in the leading half frame time and turned off in the following half frame time. The duty cycle of the output channel CH14 is 60%, representing the 1st row and the 2nd column of the light sources 22 is turned on in the leading 60% frame time and turned off in the following 40% frame time. Thus, when the control circuit 26 uses the duty cycle to control each row and each column of the light sources 22, the control circuit 26 has to obtain the luminance signal detected by the photo-sensor 24 when all of the plurality of light sources 22 is turned on. As shown in FIG. 6, the duty cycles of the output channels CH15, CH14, CH13, and CH12 are 50%, 60%, 80%, and 40% respectively, and the duty cycles of the output channels CH11˜CH0 are 100% respectively, so the control circuit 26 has to obtain the luminance signal detected by the photo-sensor 24 in the leading 40% frame time according to the minimum duty cycle 40%. It should be noted that the control circuit 26 obtains the luminance signal detected by the photo-sensor 24 according to the minimum duty cycle of plurality of light sources 22. For example, the minimum duty cycle of the 1st row of the light sources is 40%, and the minimum duty cycle of the 2nd row of the light sources is 30%, so the control circuit 26 has to obtain the luminance signal detected by the photo-sensor 24 in the leading 30% frame time.

According to the first embodiment and the second embodiment of the present invention, the backlight module 20 uses the photo-sensor 24 to detect the luminance of the plurality of light sources 22 to generate the luminance signal. When all of the plurality of light sources 22 is turned on, the control circuit 26 obtains the luminance signal detected by the photo-sensor 24. In the first embodiment, the control circuit 26 can turn off each row of the light sources 22 according to the display signal, so the control circuit 26 obtains the luminance signal detected by the photo-sensor 24 in the blanking duration. In the second embodiment, the control circuit 26 can turn off each row and each column of the light sources 22 according to the display signal, so the control circuit 26 obtains the luminance signal detected by the photo-sensor 24 in the minimum duty cycle of the plurality of light sources 22. Briefly, for the plurality of light sources that can be controlled independently, the control circuit obtains the luminance signal detected by the photo-sensor when all of the plurality of light sources is turned on.

In conclusion, the present invention provides a backlight module and a method of controlling the luminance of the backlight module. The backlight module comprises a plurality of light sources, a photo-sensor, and a control circuit. Each light source of the plurality of light sources can operate independently. The photo-sensor detects the luminance of the plurality of light sources to generate a luminance signal. The control circuit drives the plurality of light sources according to the luminance signal. When the backlight module is used in a scanning backlight LCD, the control circuit turns off parts of the plurality of light sources according to a display signal. When all of the plurality of light sources is turned on, the control circuit obtains the luminance signal so as to adjust the luminance of the backlight module according to the luminance signal.

Those skilled in the art will readily observe that numerous modifications and alterations of the device and method may be made while retaining the teachings of the invention.

What is claimed is:

1. A method of controlling the luminance of a backlight module, comprising:
providing a backlight module having a plurality of light sources;
providing a display signal;
turning off parts of the plurality of light sources according to the display signal;
obtaining the luminance of the backlight module so as to generate a luminance signal when all of the plurality of light sources being turned on; and
adjusting the luminance of the backlight module according to the luminance signal.

2. The method of claim 1, wherein providing the backlight module having the plurality of light sources comprises providing the backlight module having the plurality of light sources arranged in a plurality of rows.

3. The method of claim 2, wherein turning off the parts of the plurality of light sources according to the display signal comprises turning off one row of the plurality of light sources according to the display signal.

4. The method of claim 1, wherein turning off the parts of the plurality of light sources according to the display signal comprises adjusting duty cycles of the plurality of light sources to turn off the parts of the plurality of light sources according to the display signal.

5. The method of claim 1, wherein obtaining the luminance of the backlight module so as to generate the luminance signal when all of the plurality of light sources being turned on comprises obtaining the luminance of the backlight module so as to generate the luminance signal during the on time of the duty cycles of all of the plurality of light sources.

6. The method of claim 1, wherein obtaining the luminance of the backlight module so as to generate the luminance signal when all of the plurality of light sources being turned on comprises obtaining the luminance of the backlight module so as to generate the luminance signal in a blanking duration when all of the plurality of light sources being turned on.

7. A backlight module, comprising:
a plurality of light sources, each light source being operated independently;
a photo-sensor, for detecting the luminance of the plurality of light sources so as to generate a luminance signal; and
a control circuit, for turning off parts of the plurality of light sources according to a display signal and obtaining the luminance signal when all of the plurality of light sources being turned on.

8. The backlight module of claim 7, wherein the plurality of light sources is arranged in a plurality of rows.

9. The backlight module of claim 8, wherein the plurality of light sources in the same row can be turned off at the same time.

10. The backlight module of claim 7, wherein the control circuit adjusts duty cycles of the plurality of light sources to turn off the plurality of light sources.

11. The backlight module of claim 7, wherein the control circuit senses the luminance signal during the off time of the duty cycles of all of the plurality of light sources.

12. The backlight module of claim 7, wherein the control circuit obtains the luminance signal in a blanking duration when all of the plurality of light sources being turned on.
